(19) United States
(12) Patent Application Publication
(10) Pub. No.: US 2006/0125702 A1
(43) Pub. Date: Jun. 15, 2006

(54) Object detecting device having three-axis adjustment capability

(76) Inventor: Mataichi Kuratai, SHIGA (JP)

Correspondence Address: SUGHRUE MION, PLLC, 2100 PENNSYLVANIA AVENUE, N.W., SUITE 800, WASHINGTON, DC, 20037, US

(21) Appl. No.: 10/543,337

(22) PCT Filed: Jan. 23, 2004
(86) PCT No.: PCT/JP04/00628

§ 371 Date: Jul. 22, 2005

(30) Foreign Application Priority Data
Jan. 28, 2003 (JP) 2003-019167

(51) Int. Cl. H01Q 3/00

(52) U.S. Cl. 343/757

(57) ABSTRACT

There is provided an object detecting device having a capability of easily adjusting a detection area in three-axis directions. This object detecting device (D) having the three-axis adjustment capability includes an antenna (AT) for transmitting and receiving a sensing wave and also includes a first holder (2) supported by a support platform (1) for rotation about a first axis (R1), a second holder (3) supported by the first holder (2) for rotation about a second axis (R2) lying perpendicular to the first axis (R1), and an antenna module (4) holding the antenna (AT) and supported by the second holder (R2) for rotation about a third axis (R3) lying perpendicular to the second axis (R2).

### FIELD OF THE INVENTION

The present invention generally relates to an object detecting device for an automatic door or for security monitoring purpose and utilizing a sensing wave such as a microwave and, more particularly, to the object detecting device having a capability of easily and quickly adjusting a detection area in three-axis directions.

### BACKGROUND ART

The general object detecting device for an automatic door or for security monitoring purpose radiates a sensing wave such as a microwave towards a detection area and then receives the sensing wave reflected from a human body intruding the detection area to detect the presence of the human body in terms of a change in the frequency of the sensing wave as a result of the Doppler effect. The object detecting device of this type known in the art makes use of a patch antenna made of a metallic foil and includes a dielectric lens that is arranged rotatably in front of the antenna and becomes either a convex lens or a concave lens when rotated 90°. See, for example, the Japanese Laid-open Patent Publication No. 7-110375. In this known object detecting device, the detection area (either a wide area or a narrow area) can be adjusted by rotating the dielectric lens through 90° and the manipulation for the adjustment can easily be performed.

### DISCLOSURE OF THE INVENTION

However, even with the above object detecting device having the rotatable dielectric lens, the extent to which the detection area is adjusted or changed is limited and no satisfactory adjustment can be accomplished since only one lens is rotated.

The present invention has been developed in view of the foregoing problems and is intended to provide an object detecting device having a three-axis adjustment capability, in which three-axis adjustments including adjustments of the detection area in a leftward and rightward direction (i.e., in a first horizontal direction) and also in a forward and rearward direction (i.e., in a second horizontal direction perpendicular to the first horizontal direction) and selection of one of a wide area and a narrow area can be accomplished easily and quickly.

To this end, the present invention in accordance with one aspect thereof provides an object detecting device having a three-axis adjustment capability for transmitting and receiving a sensing wave through an antenna, which device includes a support platform, a first holder supported by the support platform for rotation about a first axis, a second holder supported by the first holder for rotation about a second axis lying perpendicular to the first axis, and an antenna module having the antenna and supported by the second holder for rotation about a third axis lying perpendicular to the second axis.

According to the foregoing object detecting device having the three-axis adjustment capability, turn of the first holder about the first axis is effective to accomplish the adjustment of the detection area in a leftward and rightward direction. Also, turn of the second holder about the second axis is effective to accomplish the adjustment of the detection area in a forward and rearward direction. Yet, turn of the antenna module about the third axis is effective to change the orientation of the antenna to change the shape of the detection area to one of wide and narrow areas. Thus, since the three-axis adjustment of the detection area can be performed easily, the installation of the object detecting device can easily and quickly be performed on site. Also, since the change of the shape of the detection area can be accomplished merely by changing the orientation of the only antenna, there is no need to use two dedicated antennas and, therefore, the number of component parts used can advantageously be decreased to thereby reduce the cost of manufacture of the object detecting device.

In a preferred embodiment of the present invention, each of the first and second holders is so shaped as to represent a semispherical configuration. By so doing, not only can a structure necessary to rotatably support the first holder and the second holder relative to each other be simplified, but the operationality in rotating the first holder relative to the support platform and also in rotating the second holder relative to the first holder can also be increased.

In another preferred embodiment of the present invention, the support platform may include a base member having a substrate and secured to an external support member, and an inner cover for covering the base member. The substrate has electronic component parts mounted thereon. In this case, the first holder has a lower outer peripheral portion sandwiched between the base member and the inner cover. According to this feature, not only can the substrate having the electronic component parts and mounted on the base member be protected by the inner cover and the first holder, but the first holder can be also supported on the support platform with no need to use any mounting member. Therefore, a mechanism for rotatably supporting the first holder can advantageously be simplified.

In a further preferred embodiment of the present invention, the object detecting device may also include a first intermittent engagement for intermittently engaging the first holder with the support platform to provide a feeling of a click as the first holder rotates relative to the support platform. According to this feature, the operator or attendant worker can turn the first holder while perceiving a feeling of a click and, therefore, the adjustment of the detection area in the leftward and rightward direction can be facilitated.

In a yet further preferred embodiment of the present invention, the object detecting device may further include a second intermittent engagement for intermittently engaging the second holder with the first holder to provide a feeling of a click as the second holder rotates relative to the first holder. According to this feature, in a manner similar to the first intermittent engagement, the second holder can be turned while the operator or attendant worker perceives the feeling of click and, therefore, the adjustment of the detection area in the forward and rearward direction can be facilitated.

In a yet further preferred embodiment of the present invention, the antenna module may be mounted on a top mount of the second holder sandwiching the top mount between a holding member for holding the antenna and a back plate that form respective parts of the antenna module. According to this feature, the antenna module can be mounted on the second holder with a simplified structure without requiring any extra mounting member.

As discussed above, in the object detecting device having the three-axis adjustment capability according to the present invention, the adjustment of the detection area in the three-axis directions can be easily and quickly accomplished at the site of installation of the object detecting device. Also, dedicated antennas for setting the wide area and the narrow area, respectively, are not required in the present invention and the turn of the only antenna is sufficient to select one of the wide and narrow areas. Therefore, the number of component parts employed can advantageously be reduced and, also, the cost of manufacture of the object detecting device of the present invention can be suppressed to a low value.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a cross-sectional view taken along the line I-I in FIG. 2, showing an object detecting device having a three-axis adjusting capability according to a first preferred embodiment of the present invention;

FIG. 2 is a front elevational view of the object detecting device, as seen through a dome-shaped outer cover;

FIG. 3 is a front elevational view of a base of the object detecting device;

FIG. 4 is a front elevational view of an inner cover of the object detecting device;

FIG. 5A is a perspective view showing a first holder employed in the object detecting device;

FIG. 5B is a bottom plan view of the first holder;

FIG. 5C is a perspective view, on an enlarged scale, of an engagement piece mounted on the first holder;

FIG. 6 is a perspective view showing a second holder employed in the object detecting device;

FIG. 7 is a front elevational view showing the manner in which an antenna module employed in the object detecting device is turned;

FIG. 8 is a diagram showing a movement of a detection area in a leftward and rightward (horizontal) direction;

FIG. 9 is a schematic diagram showing a movement of the detection area in a forward and rearward direction;

FIGS. 10A to 10C are diagrams showing the shape of an wide area when viewed from different angles;

FIGS. 11A to 11C are schematic diagrams showing the shape of a narrow area when viewed from different angles and

FIG. 12 is a circuit block diagram showing an object detecting system employed in the object detecting device.

### BEST MODE FOR CARRYING OUT THE INVENTION

Hereinafter, preferred embodiments of the present invention will be described with reference to the accompanying drawings.

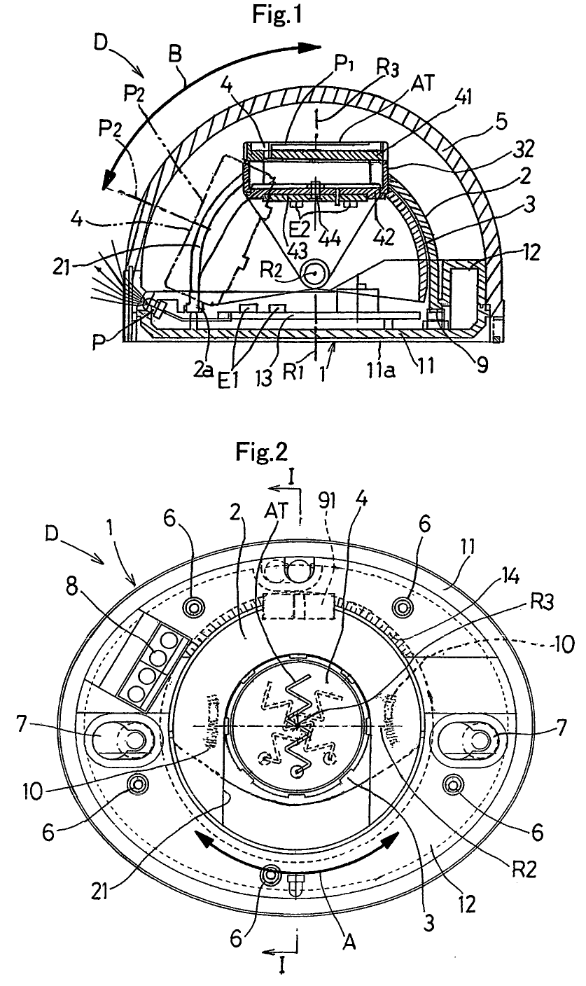

FIG. 1 illustrates, in a cross-sectional representation taken along the line I-I in FIG. 2, an object detecting device D having a three-axis adjusting capability according to one preferred embodiment of the present invention and FIG. 2 illustrates the object detecting device D in a front elevational representation.

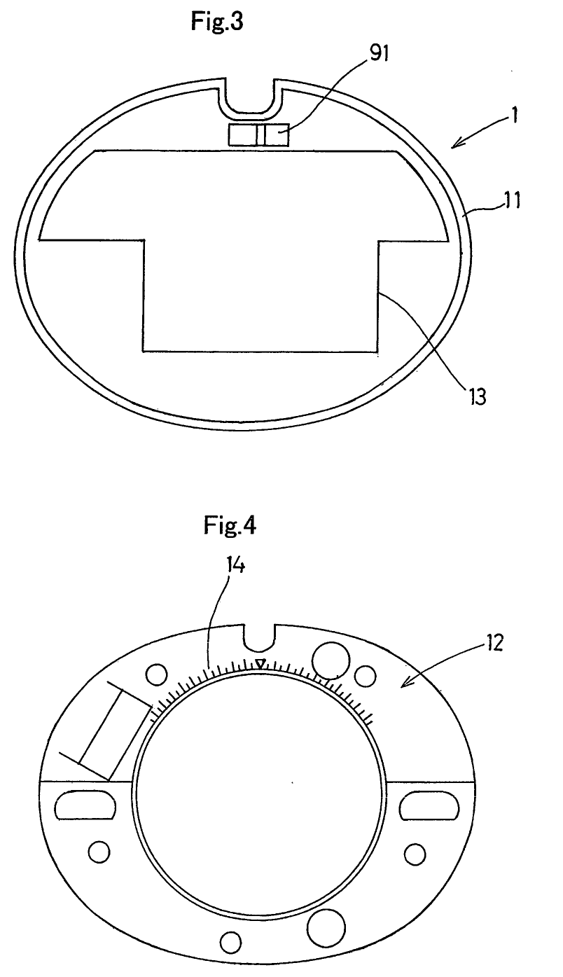

Referring to FIG. 1, the object detecting device D has a support platform 1 including a base member 11 (Also see FIG. 3.) and an inner cover 12 (Also see FIG. 4.). The base member 11 has a substrate 13 mounted thereon and is secured to an external support member such as a building wall, a building ceiling or a transom over an automatic door. The inner cover 12 covers the base member 11. The substrate 13 has electronic component parts E1 mounted thereon and forming respective parts of an object detecting circuit.

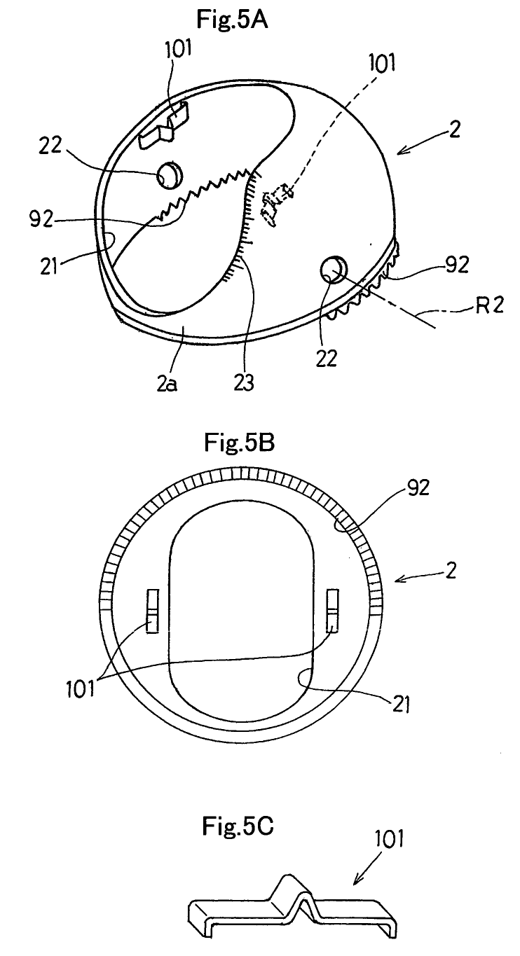

A first holder 2 of a semispherical configuration (Also see FIG. 5A) has a lower outer peripheral edge 2a movably sandwiched between the base member 11 and the inner cover 12 so that the first semispherical holder 2 can be turned about a first axis R1 lying perpendicular to a bottom surface 11a of the base member 11 that serves as a mounting surface through which the object detecting device D can be secured to the external support member referred to above. This first axis R1 may not lie perpendicular to the bottom surface 11a, but in any event extends so as to intersect the bottom surface 11a. The base member 11 and the inner cover 12 are connected together by means of screws 6 arranged at a plurality of, for example, five locations as shown in FIG. 2.

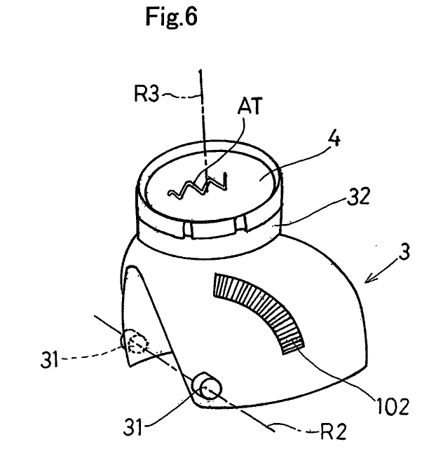

A second holder 3 (Also see FIG. 6) of a semispherical configuration is supported within the first semispherical holder 2 for rotation about a second axis R2 lying perpendicular to the first axis R1. As a means for supporting the second semispherical holder 3 within the first semispherical holder 2, the second semispherical holder 3 has a pair of support studs 31 and 31 formed therein in alignment with the second axis R2 as shown in FIG. 6, which studs 31 and 31 are rotatably engaged in corresponding stud holes 22 and 22 formed in respective portions of the first semispherical holder 2 that are aligned with the second axis R2 as shown in FIG. 5A.

As shown in FIG. 1, an antenna module 4 for transmitting and receiving sensing waves, for example, microwaves is mounted on a top mount 32 of the second semispherical holder 3 for rotation about a third axis R3 lying perpendicular to the second axis R2. This antenna module 4 includes a holding member 41 for holding an antenna AT and a back plate 42. The antenna module 4 is rotatably mounted on the top mount 32 of the second holder 3. Specifically, the holding member 41 and the back plate 42 are connected by two screws 44 with the top mount 32 sandwiched between the holding member 41 and the back plate 42 to thereby allow a rotational movement of the antenna module 4 relative to the second holder 3. The back plate 42 has a rear surface, on which a substrate 43 having electronic component parts E2 of a transceiver circuit mounted thereon is mounted. The antenna AT is, as shown in FIG. 2, in the form of a two-dimensional wire, for example, a zigzag-shaped wire. The antenna module 4 is movable in a forward and rearward direction between a position P1, shown by the solid line in FIG. 1, and a position P2, shown by the phantom line, within an opening 21 of the first semispherical holder 2 by turning the second holder 3 about the second axis R2.

A substantially dome-shaped outer cover 5 made of a synthetic resin is capped onto the support platform 1 to enclose and protect the first semispherical holder 2, the second semispherical holder 3 and the antenna module 4. An indicator element P, for example, a light emitting diode (LED) having one end connected with the substrate 13 is provided between the base member 11 and the inner cover 12 and is viewable from outside through the outer cover 5 so that whether or not the object detecting device D is activated can be ascertained from the outside.

A first intermittent engagement 9 is provided between the support platform 1 and the first semispherical holder 2 for intermittent engagement between the support platform 1 and the first semispherical holder 2, as the first holder 2 is turned about the first axis R1, so that during the first semispherical holder 2 being so turned, the operator or attendant worker can perceive a feeling of a click, that is, can feel intermittent engagement on worker's fingers. Similarly, a pair of second intermittent engagements 10 (FIG. 2) is provided between the first semispherical holder 2 and the second semispherical holder 3 for intermittent engagement between the first holder 2 and the second holder 3, as the second holder 3 is turned, so that during the second semispherical holder 3 being so turned, the operator or attendant worker can feel a similar clocking sound.

The first intermittent engagement 9 includes an engagement piece 91 in the form of a metallic plate fixedly mounted on the base 11 of the support platform 1 as shown in FIG. 3 and a series of engagement serrations 91 formed in an end face of the first semispherical holder 2 as shown in FIGS. 5A and 5B. This first intermittent engagement 9 is so designed that during the turn of the first semispherical holder 2 the engagement piece 91 can be intermittently engaged with the engagement serrations 91 to provide the feeling of click to the operator or attendant worker. The turn of the first semispherical holder 2 can be carried out while the operator or attendant worker looks at calibrations 14 formed in an edge portion of the inner cover 12 as shown in FIG. 4 and, accordingly, a highly accurate adjustment can be accomplished.

Similarly, each of the second intermittent engagements 10 shown in FIG. 2 includes a respective engagement piece 101 in the form of a metallic plate fixedly mounted on an inner surface of the first semispherical holder 2 as shown in FIGS. 5A to 5C, and a series of engagement serrations 102 formed in an outer surface of the second semispherical holder 3 as shown in FIG. 6. This second intermittent engagement 10 is so designed that during the turn of the second semispherical holder 3 the engagement piece 101 can be intermittently engaged with the engagement serrations 102 to provide the feeling of click to the operator or attendant worker. The turn of the second semispherical holder 3 can also be carried out while the operator or attendant worker looks at calibrations 23 formed in an edge portion of the opening 21 of the first semispherical holder 2 as shown in FIG. 5A and, accordingly, a highly accurate adjustment of the second holder 3 can be accomplished as is the case with the first semispherical holder 2.

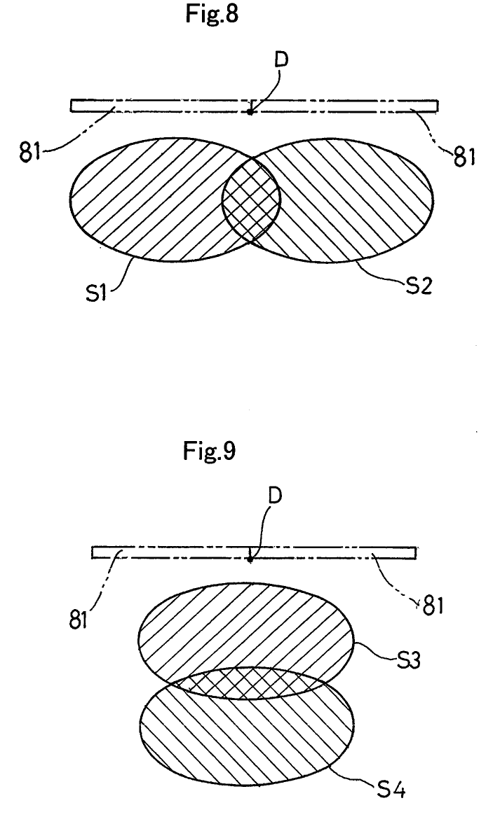

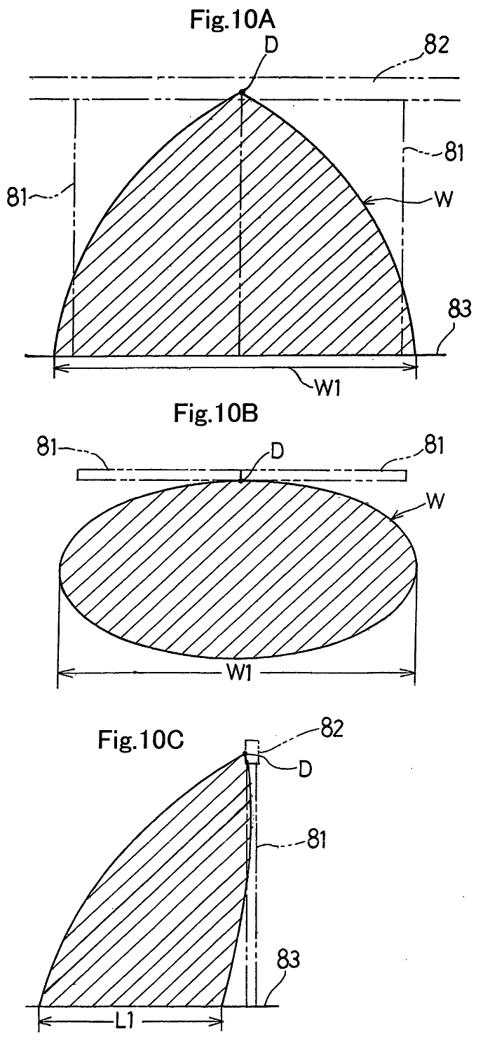

The object detecting device D so constructed as hereinabove described is mounted on, for example, a transom 82 over an automatic slide door 81, as shown in FIG. 10, through mounting holes 7 (FIG. 2) defined in the support platform 1. Setting of the detection area that can be covered by the object detecting device D is carried out in the following manner. In the first place, setting of the detection area in a leftward and rightward direction is carried out by turning the first semispherical holder 2 relative to the support platform 1 (FIG. 1) over a predetermined angular distance about the first axis R1 in a direction shown by the arrow A. At this time, when viewed from top, the detection area moves leftwards or rightwards relative to the door 81 or in a first horizontal direction substantially parallel to the door 81, as shown by S1 or S2 in FIG. 8, respectively. Setting of the detection area in a forward and rearward direction (in a second horizontal direction perpendicular to the first mentioned horizontal direction and also to the door 81) is carried out by turning (or angularly moving forwards or rearwards) the second semispherical holder 3 relative to the first semispherical holder 2 (FIG. 1) over a predetermined angular distance about the second axis R2 in a direction shown by the arrow B. At this time, when viewed from top, the detection area moves forwards or rearwards relative to the door 81 in the second horizontal direction as shown by S3 or S4, respectively, in FIG. 9.

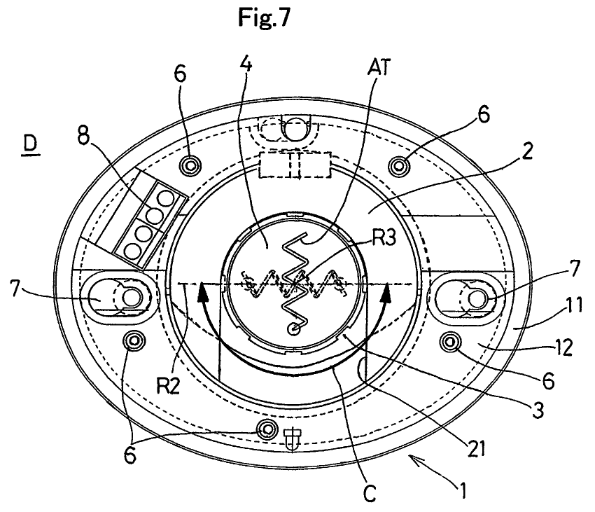

Selection of one of detection area shapes including a wide area and a narrow area is carried out by turning the antenna module 4 relative to the second semispherical holder 3 (FIG. 1) over a predetermined angular distance about the third axis R3 in a direction shown by the arrow C in FIG. 7 to change the orientation of the antenna AT. Specifically, when the antenna module 4 is turned to orient the antenna AT in a direction shown by the solid line in FIG. 7, the wide area W can be set, which covers an area of large width in front of the site of installation of the object detecting device D, as shown in FIGS. 10A and 10B. The detection area represented by this wide area W represents a transversely elongated, substantially oblong shape (as shown in FIG. 10B) when viewed from top, which oblong shape has a width W1 (FIG. 10A) as measured on a floor 83 when viewed from front and, also, has a relatively small depth L1 as measured on the floor 83 when viewed from laterally. The detection area represented by this wide area W is conveniently employed for a sensor suitably used in association with an automatic double door 81.

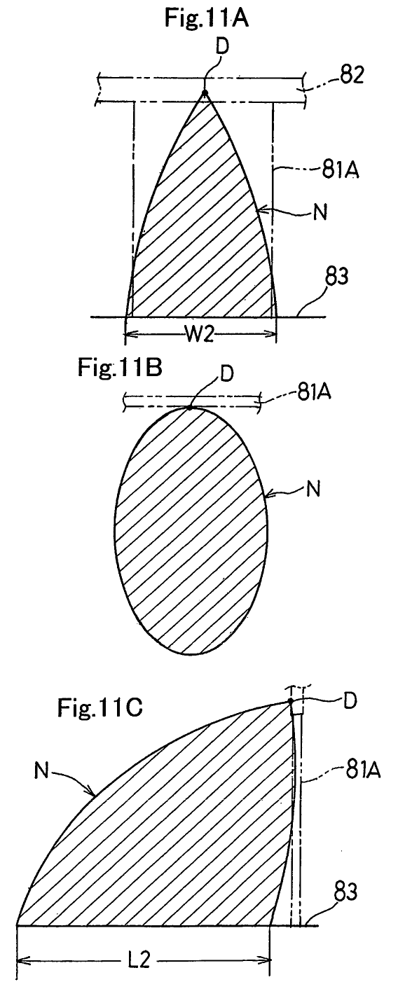

When the antenna module 4 is turned to orient the antenna AT in a direction shown by the broken line in FIG. 7, the narrow area N can be set, which has an area of small width in front of the site of installation of the object detecting device D as shown in FIGS. 11A to 11C. Specifically, the detection area represented by this narrow area N represents a forwardly elongated, substantially oblong shape (as shown in FIG. 11B) when viewed from top, which oblong shape has a width W2 (FIG. 11A), as measured on the floor 82 when viewed from front, that is smaller than the width W1 shown in FIG. 10A, and also has a larger depth L2 (as shown in FIG. 11C) than the depth L1 shown in FIG. 10C when viewed from laterally. The detection area represented by the narrow area N is conveniently employed for a sensor suitably used in association with an automatic single door or swinging door 81A.

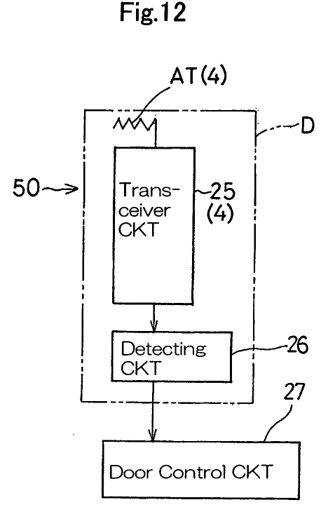

When the object detecting device D is used in association with an automatic door system 50 shown in FIG. 12, by the operation of a transceiver circuit 25 provided in the antenna module 4, the antenna AT in the antenna module 4 radiates the sensing wave in the form of a microwave, and the sensing wave reflected from an object such as a moving human body can be received by the transceiver circuit 25 through the antenna AT. When the frequency of the sensing wave reflected from the object and subsequently received by the transceiver circuit 25 undergoes a change by the Doppler effect, such change can be detected by a detecting circuit 26. The detection result given by the detecting circuit 26 is then supplied to an external door control circuit 27, shown in FIG. 12, through a wiring connected to a connection terminal 8 shown in FIG. 2, to control selective opening or closure of the automatic door.

As discussed above, in controlling the automatic door, orientation of the antenna AT in the antenna module 4 can be suitably selected in consideration of the environment in which the object detecting device D is installed. Specifically, in the case of the automatic double door 81 shown in FIG. 10, the antenna module 4 has to be turned about the third axis R3 to cause the antenna AT to be oriented as shown by the solid line in FIG. 7 so that the detection area can be set as the wide area as shown in FIG. 10. On the other hand, in the case of the automatic single door as shown in FIG. 11 or the automatic swinging door, the antenna AT has to be oriented as shown by the broken line in FIG. 7 so that the detection area can be set as the narrow area as shown in FIG. 11.

With the object detecting device D having the three-axis adjustment capability according to the present invention as hereinbefore described, not only can the detection area be adjusted in the leftward and rightward direction (the first horizontal direction) substantially parallel to the door and also in the forward and rearward direction (the second horizontal direction substantially perpendicular to the first horizontal direction), but also depending on the environment in which the object detecting device D is installed, selection of one of the wide area W shown in FIG. 10 and the narrow area N shown in FIG. 11 can be easily and quickly performed on the site of mounting the device D. In particular, since the setting of one of the wide area W and the narrow area N can be easily accomplished by turning the antenna module 4, there is no need to use two dedicated antennas, one for the wide area W and the other for the narrow area N, and, therefore, the number of component parts employed in the detecting device D can advantageously be reduced. Accordingly, the object detecting device D can be manufactured at a reduced cost, having a compact size and an excellent handling capability.

It is to be noted that although in the foregoing embodiment the antenna AT has been shown and described as employed in the form of the wire, it may be in the form of a patch antenna made of metallic foil. Also, the object detecting device D of the present invention can be used not only as a sensor for the automatic door, but also as a security sensor for detecting an unauthorized entry of an intruder and then issuing a warning output.

What is claimed is:

1. An object detecting device having a three-axis adjustment capability for transmitting and receiving a sensing wave through an antenna, which comprises:
a support platform;
a first holder supported by the support platform for rotation about a first axis;
a second holder supported by the first holder for rotation about a second axis lying perpendicular to the first axis; and
an antenna module including the antenna and supported by the second holder for rotation about a third axis lying perpendicular to the second axis.

2. The object detecting device having the three-axis adjustment capability as claimed in claim 1, wherein each of the first and second holders is of a semispherical configuration.

3. The object detecting device having the three-axis adjustment capability as claimed in claim 1, wherein the support platform includes a base member having a substrate and adapted to be secured to an external support member, and an inner cover for covering the base member, the substrate having electronic component parts mounted thereon, and wherein the first holder has a lower outer peripheral portion sandwiched between the base member and the inner cover.

4. The object detecting device having the three-axis adjustment capability as claimed in claim 1, further comprising a first intermittent engagement for intermittently engaging the first holder with the support platform to provide a feeling of a click as the first holder rotates relative to the support platform.

5. The object detecting device having the three-axis adjustment capability as claimed in claim 1, further a second intermittent engagement for intermittently engaging the second holder with the first holder to provide a feeling of a click as the second holder rotates relative to the first holder.

6. The object detecting device having the three-axis adjustment capability as claimed in claim 1, wherein the antenna module is mounted on a top mount of the second holder by sandwiching the top mount between a holding member for holding the antenna and a back plate, the holding member and the back plate forming respective parts of the antenna module.
